(19) United States
(12) Patent Application Publication
(10) Pub. No.: US 2007/0052919 A1
(43) Pub. Date: Mar. 8, 2007

(54) Frame for glasses with add-on element

(75) Inventors: Pier Giorgio Antognazza, Venegono Inferiore (Varese) (IT); Maria Stefania Antognazza, Venegono Inferiore (Varese) (IT); Gianluigi Antognazza, Venegono Inferiore (Varese) (IT)

Correspondence Address: YOUNG & THOMPSON, 745 SOUTH 23RD STREET, 2ND FLOOR, ARLINGTON, VA, 22202, US

(73) Assignee: LA GIARDINIERA S.R.L., VENEGONO INFERIORE (VARESE) (IT)

(21) Appl. No.: 11/376,177

(22) Filed: Mar. 16, 2006

(30) Foreign Application Priority Data
Sep. 7, 2005 (IT) MI2005U000305

(51) Int. Cl. G02C 7/08

(52) U.S. Cl. 351/57

(57) ABSTRACT

A frame for sunglasses, of the type including a front-piece (1), nose bridge elements (5), and an add-on element (6) to support prescription (RX) lenses which may be removably applied to the inner side of the frontpiece (1), wherein the nose bridge (5) includes of a separate piece and has a head portion (4), the frontpiece has in its middle portion a recessed seat (3) equipped with a raised land (3a) whereto the head (4) of the nose bridge (5) may be fastened, and the add-on element (6) has a fork element (F₁, F₂) which may be snap-fastened to the head (4) of the nose bridge (5).

The present invention concerns a frame for glasses, in particular a frame designed to house an add-on element.

As known, glasses frames have long existed which are designed to be able to house an add-on element, i.e. an easily-removable accessory structure supporting a pair of add-on lenses.

The add-on lenses may be sunscreen lenses, to be applied to eye-glasses: in that case the add-on element is normally applied to the outer side of the main frame. Viceversa, in case the accessory lenses are prescription (RX) lenses, to be applied to a pair of sunglasses, the add-on element is normally applied to the inner side of the frame. In this context, as it can be guessed, the inner side of the frame is to be intended as the one facing the user's eyes.

The present invention concerns this last type of add-on element, which requires the arrangement of suitable attaching means on the inner side of the frame.

There are many configurations of glasses frames which may be equipped with add-on elements, some examples thereof being IT 1180711, WO 98/34150 and U.S. Pat. No. 5,929,963, but there are many other examples which can be traced in the field of reference.

In many cases, frame configuration is extremely complex, requiring the use of costly moulds or a certain assembling complexity and having an unpleasant appearance. Moreover, the nose bridge—i.e. the portion equipped with pads resting on the user's nose—is normally a piece integral either with the frame or with the add-on element: this solution is not always the most preferable one, both because it may imply a certain moulding complexity, and because it restrains the choice concerning size and material of the nose bridge; finally, said nose bridge does not appear to be adjustable to the end user's specific requirements, the user hence not being able to suitably adjust the width thereof complicating the centring of the lens focus.

It is an object of the present invention to offer a frame for sunglasses which can be equipped with a structurally simple and inexpensive add-on element, which is practical and quick to assemble, long-lasting and equipped with an add-on adjustable nose bridge.

Such object is achieved by means of the invention described in its essential features in the accompanying claims.

Further features and advantages of the invention will in any case be more evident from the following detailed description, given by way of example and illustrated in the accompanying drawings, wherein:

FIG. 1 is a partly cross-section elevation view of the inner side of the frame according to the invention;

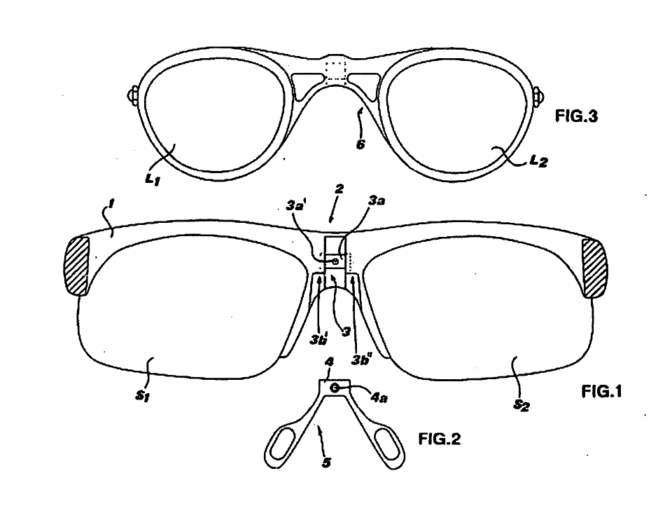

FIG. 2 is an elevation view of a nose bridge which may be applied to the frame of FIG. 1;

FIG. 3 is an elevation view of an add-on element according to the invention;

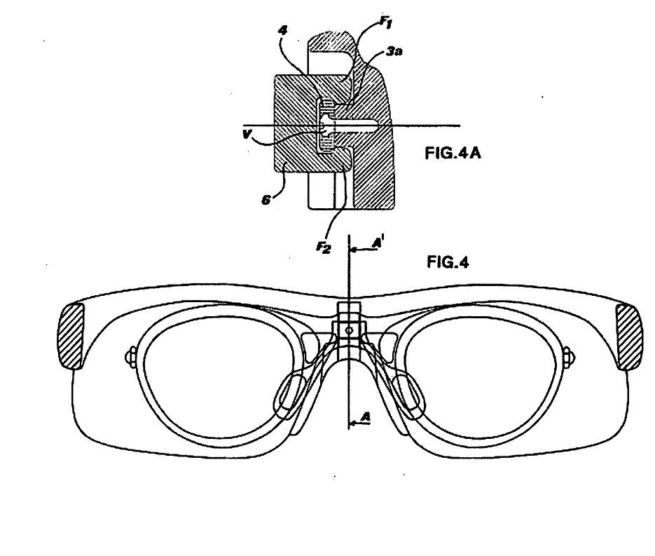

FIG. 4 is a see-through view of the frame assembled together with the nose bridge and with the add-on element according to the invention; and

FIG. 4A is a section view along line A-A′ of FIG. 4.

As shown in FIG. 1, a main frame 1 is shaped so as to support a pair of sunlenses S₁ and S₂. From the frame side ends, two suitably hinged stems (shown in cross-section) depart in a manner known per se.

According to the invention, a recessed seat 3 is provided in the middle part of the frame, in correspondence of nose bridge 2 between the two lenses S₁ and S₂, which seat is obtained in the frame thickness, for example during moulding.

Seat 3, in particular, has a raised land 3a (visible also in FIG. 4A) whereon a retaining head 4 of a nose bridge 5 is in-tended to be applied. For such purpose, the head 4 of the nose bridge according to the invention preferably has a through-hole 4a into which a self-tapping screw V is introduced, which screw is intended to be screwed into a corresponding hole 3a′ in the land 3a.

By means of screw V, nose bridge 5 may hence be fastened to frame 1. Preferably, seat 3 further has two undercut portions 3b′ and 3b′, at the sides of raised land 3a, under which the side edges of head 4 remain further blocked: in this case, during assembly, nose bridge 5 is caused to slide from the frame lower part to the upper part thereof, introducing below undercuts 3b′ and 3b″ the side portions of head 4, giving the assembly greater strength and providing good protection of the sharp edges of head 4 of the nose bridge 5, which remains hidden under the undercuts 3b′, 3b″.

Said nose bridge, which is available as an add-on and hence may be manufactured separately, preferably consists of a ductile metal material, so as to define a structure which can be deformed and is hence adjustable (for example by spreading apart by the desired measure the two nose bridge branches) to the user's nose features. For example, at least the fork structure of the nose bridge (i.e. the portion comprising the two diverging branches) is made of nickel silver.

The head portion 4 of the nose bridge which instead remains visible through the opening of seat 3, according to the invention advantageously acts as a fastening element for an add-on element 6.

In particular, add-on element 6 is in the shape of a small front-piece, of a much smaller overall size than the main frontpiece of frame 1, which supports a pair of prescription (RX) lenses L₁ and L₂ of a suitable strength.

In the centre, add-on element 6 has an elastic-fork portion (shown by a dotted contour in FIG. 3), shaped so as to have a sort of upper jaw F₁ and a lower jaw F₂ which are partially elastic and intended to overcome—by elastic deformation—the thickness of head 4 of the nose bridge and to snap tightly around it (FIG. 4A). For such purpose, it is evident that the height of head 4 must be greater than the height of raised land 3a, so as to define a suitably-sized step (for example, head height 4 mm, height of land 3a 3.4 mm and the steps for fastening F₁ and F₂ are each 0.3 mm) in order to cause snap-retaining of the two jaws F₁ and F₂ of the add-on element.

As can be appreciated in FIG. 2, the currently preferred shape of the head 4 of the nose bridge consists of a substantially rectangular plate, between 1.2 mm and 1.4 mm thick, preferably 1.3 mm.

Preferably, for lightness and cost reasons, but also to facilitate coupling thereof with head 4 of the nose bridge, the add-on element frame is made of plastic material.

Thanks to the configuration according to the invention, the objects set forth in the preliminary remarks are fully achieved. Amongst other things, since nose bridge 5 can be advantageously manufactured in a metal material, head 4 of the nose bridge represents an extremely stable and long-lasting fastening means for the add-on element, preventing undesired coupling plays which are otherwise related to the wear which would occur if the two engageable parts were both made of plastics.

It is intended, however, that the scope of the invention described above is not limited to the particular embodiment shown, but extends to any other construction variant which exploits the same teaching within the definition given in the appended claims.

For example, the same advantageous teachings offered here are exploited if it is expected that the main frontpiece is equipped with interchangeable sunlenses (i.e. expecting the possibility that the lenses be easily replaced by the end user, with other, differently shaped and/or tinted sunlenses).

1) A frame for sunglasses, comprising a frontpiece (1), nose bridge means (5) and an add-on element (6), apt to support prescription (RX) lenses, which can be removably applied to the inner side of said frontpiece (1), wherein
said nose bridge (5) consists of a separate piece and has a head portion (4),
said frontpiece has in its middle portion a recessed seat (3) equipped with a raised land (3a) whereto said head (4) of the nose bridge (5) can be fastened, and
said add-on element (6) has a fork element (F₁, F₂) which can be snap-fastened to said head (4) of the nose bridge (5).

2) The frame as in claim 1), wherein said head (4) of the nose bridge is apt to be fastened to the raised land (3a) by screw means.

3) The frame as in claim 1), wherein said recessed seat (3) further has a pair of opposite lateral undercut recesses (3b′, 3b″) into which side edge portions of head (4) of nose bridge (5) can be slidingly introduced.

4) The frame as in claim 1), wherein at least said head (4) of the nose bridge is made of a metal material.

5) The frame as in claim 4), wherein said head (4) is shaped as a substantially rectangular plate.

6) The frame as in claim 4), wherein the entire nose bridge (5) is made of a deformable metal material.

7) The frame as in claim 6), wherein said nose bridge (5) comprises a two-fork portion which can be adjusted to the user's facial features.

8) A pair of sunglasses, comprising a frame as claimed in claim 1).
